(19) United States
(12) Patent Application Publication
(10) Pub. No.: US 2014/0300241 A1
(43) Pub. Date: Oct. 9, 2014

(54) ELECTRICAL MACHINE MEDIUM VOLTAGE COIL INSULATION SYSTEMS AND METHODS

(71) Applicant: Integrated Power Services, Greenville, SC (US)

(72) Inventors: Ray Thomas Reid, Greer, NC (US); Mark D. Nikrandt, Pittsburgh, PA (US); Donald Dolence, Pittsburgh, PA (US)

(21) Appl. No.: 14/309,634

(22) Filed: Jun. 19, 2014

Related U.S. Application Data
(63) Continuation-in-part of application No. 13/774,014, filed on Feb. 22, 2013.

(51) Int. Cl. H02K 3/34

(52) U.S. Cl. CPC H02K 3/345
USPC 310/215

(57) ABSTRACT

An insulation system and method are disclosed for insulating formed coils of electrical machines, such as motors and generators. The system and methods additionally apply to refurbishing of the formed coils. The system includes strand/turn insulation that may include one or more layers of different materials, depending upon the dielectric requirements. A ground wall insulation is applied over the group of turns. The coil may be sized in a slot cell section. Additional insulation layers are provided, including an armor layer. The various insulation layers may each be applied in one continuous wrap. The resulting system is highly adaptable to different machine designs and ratings, and affords superior resistance to degradation.

This application is a Continuation-in-Part Application of U.S. Non-provisional patent application Ser. No. 13/774,014, entitled “Electrical Machine Coil Insulation System and Method”, filed Feb. 22, 2013, which is herein incorporated by reference in its entirety.

### BACKGROUND

The invention relates generally to motor winding and insulation, and in particular to multi-layer, high performance insulation systems for use in medium voltage applications.

A number of insulation systems and techniques have been developed and are in use for generators, motors, and other rotating electrical machines. In the case of generators, such machines include a stator, and a rotor that is disposed in the stator and is caused to rotate via an external apparatus, such as a turbine or gas engine system. Rotation of the rotor may create a flow of electric current through the stator, thus converting mechanical motion into electric power. In some cases, the generator may additionally include, for example, electrically powered field coils (e.g., exciter coils) that may improve electric power production over the use of permanent magnets only.

In the case of a motor, electric power may be provided to the stator, and the influence of electric fields generated by the stator may cause the rotor to rotate, thus converting electric power to mechanical motion. In most such machines, both the stator and the rotor comprise a core and coils or windings of conductive material that carries current in operation. Such coils must generally be insulated from both the core material as well as from one another. Insulation systems for motors and generators take various forms, which may be more or less elaborate depending upon such factors as the nature of the machine, the voltage and currents encountered during operation, the voltage differences between neighboring coils, the power rating of the machine, and so forth. In simple systems, varnish or resinous insulation may suffice. However, in medium voltage, higher voltage, and larger machines much more demanding conditions exist either continuously or during periods of operation, requiring more complex, often multi-layer insulation systems.

Coil insulation systems serve several purposes, and these differ somewhat at different locations along the coil and in different environments. For example, because coils are typically forced into slots within the stator and rotor cores, insulation must withstand mechanical treatment during manufacture, and maintain potential differences between the coil and the surrounding slot material. Similarly, multiple coils are often placed in each slot, and these coils experience different potentials during operation. The insulation systems must thus maintain and reduce this difference without breakdown. At coil ends (outside the core), the coils are often in close proximity with one another, and so must also maintain potential differences at these locations.

Such insulation systems are applied both initially, during manufacture of the machines, and may also be applied during reworking or servicing. At both stages, improvements are needed to existing insulating techniques. For example, existing systems still suffer from varying potentials under certain operating conditions. Moreover, the core materials and coil conductors essentially provide the only parts of the machine that contribute usefully to the power output of motors or of power created in generators. Insomuch as the insulation system occupies valuable space in the machine, reductions in its size, improvements in performance, or both, allow for improved machine performance, increased power rating, reduced derating, and so forth. Because the insulation systems are applied both initially and during the life of the machines, such improvements offer advantages in original designs as well as in retrofitting opportunities.

### BRIEF DESCRIPTION

The invention provides a multi-layer insulation system for motors and other electrical machinery that can be adapted to particular voltages, current and flux densities, winding configurations and so forth to provide enhanced performance and resistance to corona breakdown. The systems and method of the invention may be utilized in both new machine fabrication as well as in reworking or refurbishing applications that improve performance as compared to original manufacturer insulation system. Advantageously, the techniques described herein provide for engineered insulation systems suitable for use in aftermarket motor and generator repair industries. The insulation systems described herein may meet a variety of standards and tests, including standards and tests for the institute of electrical and electronic engineers (IEEE), national electrical manufacturers association (NEMA), and underwriters laboratory (UL) compliance. For example, the systems described herein may attain UL PTDR certification for motors for use in hazardous locations, and may additionally attain UL PTKQ certification for rebuilt motors and generators for use in hazardous locations, nuclear locations, and the like. A variety of generator and motor types may be refurbished, including definite purpose motors, harsh duty motors, and/or general purpose motors.

In a first embodiment, an electrical machine formed coil insulation system is provided. The system includes turn insulation disposed over each successive turn of the formed coil. The system further includes multi-layer of mica ground wall insulation disposed over multiple turns of the coil. The system additionally includes armor insulation disposed over ends of the coil and at least a portion of coil leads, wherein the turn insulation is disposed in one continuous wrap, and wherein the form coil insulation system is rated for an electrical machine operating at between 0 and 7,000 volts.

In a second embodiment, an electrical machine refurbished formed coil insulation system is provided. The system includes turn insulation comprising at least one layer of a mica-containing tape disposed over each successive turn of substantially the entire formed coil. The system additionally includes multi-layer of mica ground wall insulation comprising at least one layer of a mica-containing tape disposed over multiple turns of substantially the entire the coil. The system further includes armor insulation disposed over at least a portion of the ground wall insulation of at least slot cell cavity sections of the coil and extending beyond ends of a core of the machine, wherein the turn insulation is disposed in one continuous wrap.

In a third embodiment, method for refurbishing insulation insulating an electrical machine formed coil is provided. The method includes removing previous insulation from the formed coil. The method additionally includes wrapping a turn insulation over each successive turn of the formed coil and wrapping a multi-layer of mica ground wall insulation over multiple turns of the coil. The method further includes wrapping an armor insulation over the ground wall insulation of slot cell sections of the coil and extending beyond ends of a core of the machine. The method additionally includes vacuum pressure impregnating the coil and insulations, wherein the turn insulation is wrapped in one continuous wrap.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary electrical machine in which the present coil insulating techniques may be applied;

FIG. 2 is a perspective view of an exemplary rotor of such a machine;

FIG. 3 is a perspective view of a portion of a stator in which coils insulated in accordance with the present disclosure are being installed;

FIG. 4 is a perspective view of an exemplary formed coil on which the insulation system may be applied;

FIG. 5 is an end view of a coil of the type shown in FIG. 4;

FIG. 6 is a bottom view of the coil shown in FIGS. 4 and 5, illustrating an exemplary placement of components of the insulation system;

FIG. 7 is a perspective view of an exemplary coil comprising a number of turns of a conductor and elements of the insulation system;

FIG. 8 is a diagrammatical side view of an exemplary coil with components of the insulation system;

FIG. 9 is a diagrammatical sectional view of an exemplary coil showing components of the insulation system adjacent to an end of a stator core;

FIG. 10 is a flow chart illustrating steps in creating, insulating and testing the insulation system, along with features and advantages of the steps or phases of the process.

### DETAILED DESCRIPTION

The techniques described herein enable for the creation of improved insulated formed coil systems. In one embodiment, tape insulation is applied in various layers, suitable for protecting the underlying conductor (e.g., copper conductor) while in use. In certain embodiments, each layer of insulation may be applied as a continuous wounding of tape, thus saving space that may have resulted from transitions of multiple tape rolls. The extra space may be used, for example, to provide for further conductor area (e.g., more copper conductor), thus improving performance of the system. In the middle voltage and power applications contemplated herein, the insulation may forgo the use of a corona tape and gradient tape. More specifically, unlike higher voltage insulation systems, such as insulation systems described with respect to patent application Ser. No. 13/774,014, which is incorporated herein in its entirety, the techniques described herein may enable more efficient continuous tape windings and the application of certain resins and dry tape more suitable for middle voltage and/or power applications. The systems and methods described herein may be applied to refurbishing motors and generators with engineered insulation systems that meet a variety of tests and guidelines, including IEEE, NEMA, and UL tests and guidelines.

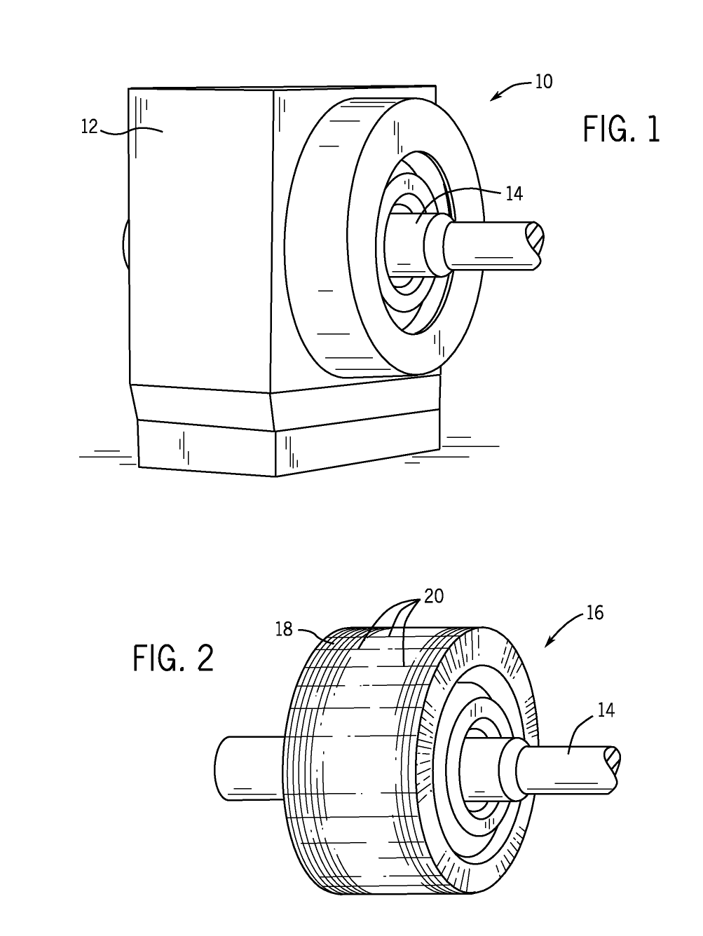

Turning now to the drawings, the insulation system and technique described in the present disclosure may be applied to a variety of electrical machines, and in particular to generators and motors. An exemplary generator is illustrated in FIG. 1. The generator 10 generally comprises, in this view, a housing 12 from which a shaft 14 extends. As will be appreciated by those skilled in the art, the shaft 14 may be mechanically coupled to a turbine or other power source. As the engine is loaded, causing the shaft 14 to rotate, the magnetic interaction between the rotating shaft and the stator may produce electric power. If the insulation system is applied to a motor, this process is generally reversed. That is, electric power would be applied to the stator, producing a magnetic field, and the interaction of the magnetic field and currents within the motor would case the shaft 14 to rotate. The shaft 14 may then be mechanically coupled to various loads to provide for rotative power. Many different styles, types, sizes, voltage ratings, and so forth may be accommodated by the present insulation techniques. However, the techniques are particularly well-suited to medium voltage generators and motors, such as on the order of approximately 2,000 to 7,000 volts. Power ranges for the insulation system may vary, for example, between 500 kW and 20,000 kW. In general, these machines will be multi-phase, such as three-phase in the case of most generators, e.g., wye or delta generators, and motors.

FIG. 2 illustrates an exemplary rotor 16 from a generator of the type shown in FIG. 1. The shaft 14 extends from the rotor and mechanical components link the shaft to the rotor core 18. The rotor core will have a series of slots 20 in which rotor windings are disposed. The windings may be interconnected based upon the particular generator design, the power generated by the generator, ratings of the generator, the number of poles in the generator, and so forth.

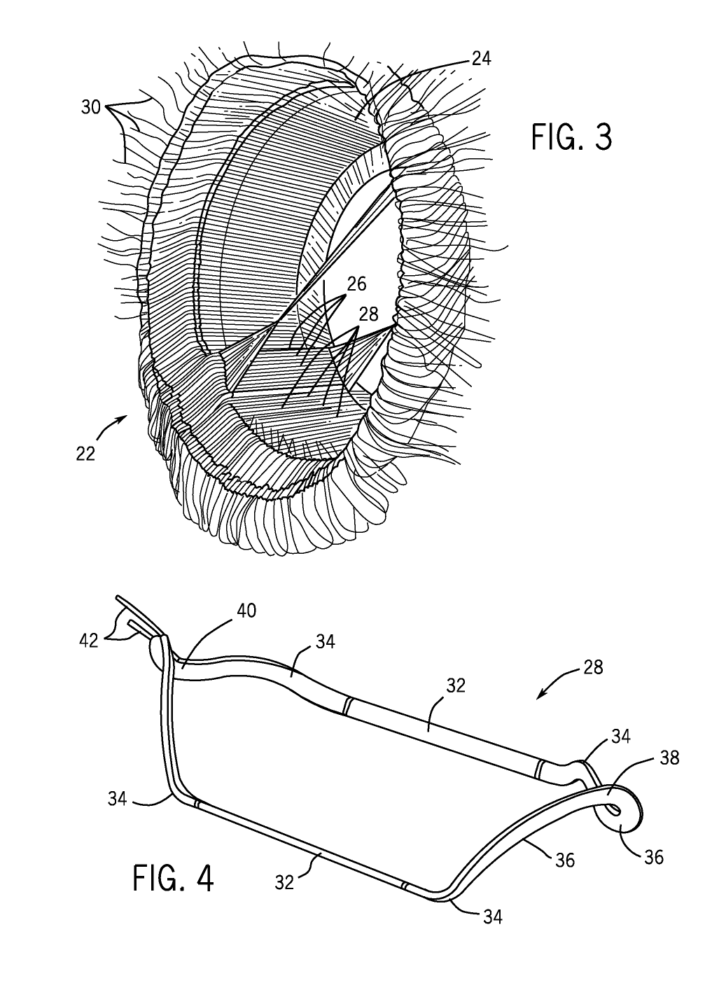

FIG. 3 illustrates an exemplary stator for a generator of the type shown in FIG. 1, in the process of construction. The stator 22 is mounted and statically held within the housing of the machine, and the rotor is later placed within the assembled stator, supported by bearings, such that it may rotate within the stator. A large central opening is therefore provided in the stator core 24. Around the inner periphery of the stator core 24 are a series of slots 26. The length, number, and position of the slots may vary depending upon the number of poles in the machine, the power rating of the machine, the number of phases, and so forth. In particular, windings or coils 28 are disposed in the slots, and in many cases multiple coils (e.g., two) may be disposed in each slot. The coils 28 may include coils that have been previously used, for example by operating for greater than 10, 20, 40, 100 hours or more in situ. Accordingly, the coils 28 may be removed and worked on for refurbishment and reinstalled, or for resale as an aftermarket system after refurbishment. Various slot geometries, winding patterns and combination of windings within the slots may be employed, again depending upon the motor design. In general, the coils may have leads that extend through a single end of the motor stator core, or leads may extend from both sides. The leads 30 are ultimately laced and interconnected to form groups and phases of the stator. The interconnections may thus allow for multi-phase operation, while providing a desired number of poles and a suitable winding configuration (e.g., wye or delta).

The present disclosure is directed in particular toward formed coils suitable for providing for medium voltage and or power applications (e.g., 2,000 to 7,000 volts, between 500 kW and 20,000 kW). That is, the coils disposed in the stator slots are formed and insulated prior to installation in the slots, with certain operations being performed following installation (e.g., vacuum pressure, integration, or “VPI”). Such formed coils are generally essentially complete prior to installation into the stator slots, and form what can be large, generally rigid structures containing the electrical conductors that will carry current and generate electrical fields or be influenced by electrical fields during operation. As will be appreciated by those skilled in the art, significant potential differences may be developed between the coils in the stator slots, between the coils and the stator core material, between adjacent coils at ends of the stator, and so forth. The present insulation system and techniques allow for maintaining such potential differences while avoiding breakdown of the insulation system that can cause premature failure or degrade a performance characteristic of a machine.

FIG. 4 illustrates an exemplary formed coil insulated in accordance with the present disclosure. The coil 28 generally includes two slot cell sections 32 opposite one another that are configured and insulated to fit within slots of the stator core. On ends of the slot cell sections, bends 34 are formed. The coil illustrated in FIG. 4 has end arms 36 joined by an end winding 38 to form a loop that is completed by a knuckle 40 around which conductors extend prior to being terminated at leads 42. Electrically, then, the coil comprises a circuit that begins at one lead, winds around multiple turns comprised in the various sections of the coil, and that terminates again in the opposite lead. As described in more detail below, the various sections of the coil are insulated in specific ways to provide optimal performance and resistance to degradation, including voltage and/or power differentials in a medium range (e.g., 2,000 to 7,000 volts, 500 kW and 20,000 kW).

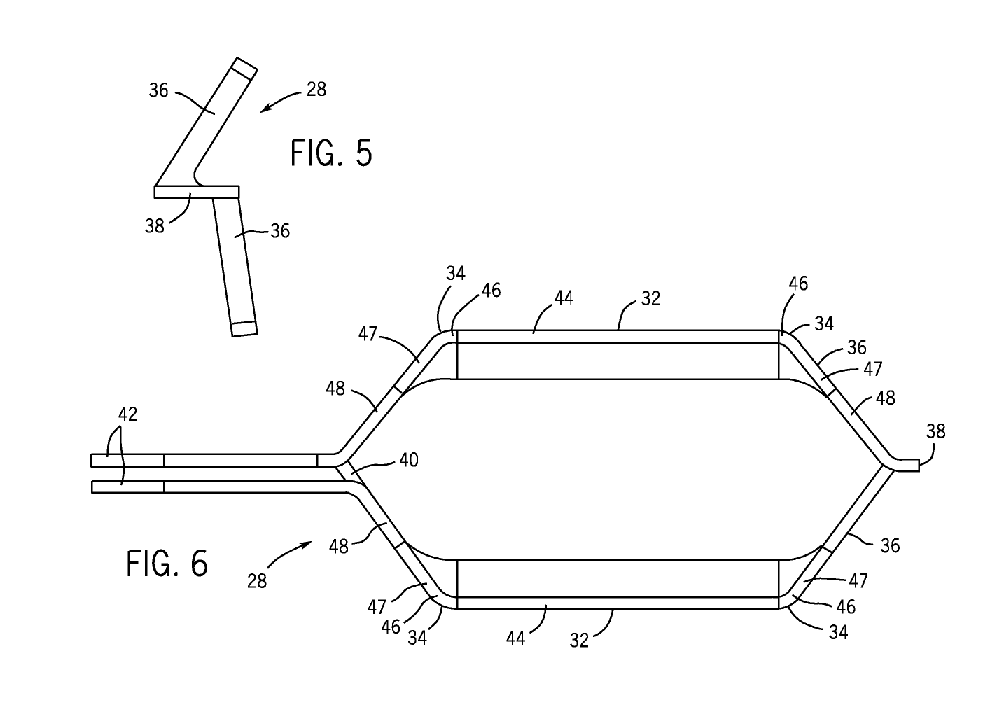

An end view of the coil is illustrated in FIG. 5, while a bottom view is illustrated in FIG. 6 in which the multiple different types of insulation layers are called out. As can be seen in FIG. 5, the end winding 38 extends between the end arms 36 and completes the loop of the conductors within the coil winding. As shown in FIG. 6, this structure places both leads 42 at one end in a loop arrangement comprising the slot cell sections 32, the bends 34, and end arms 36, the end winding 38, and the knuckle 40. Insulation is applied to these various sections both prior to, during, and following forming of the sections. That is, certain portions of the insulation are applied, followed by forming, then by application of additional insulation as described below.

As shown in FIG. 6, the insulation system, from a coil geometry standpoint, may be considered to have several regions. First, in a slot cell section insulation system 44 is disposed over the slot cell sections 32. This insulation system is designed to isolate individual strands (where desired) from one another, individual turns from one another, and the slot cell sections from other slot cavity sections in slots of the machine core, as well as from the machine core material itself. The slot cell section insulation system comprises multiple layers as described more fully below. A voltage suppression layer 46 extends across and beyond the slot cell section insulation system and allows for reduction of surface voltage stress where the coil contacts the stator core. An armor tape layer 47 is employed on the coil extension 48. The armor tape layer may extend toward the coil end turn and knuckle on both ends of the coil. The armor tape layer 47 allows for further protection of the underlying tape layers.

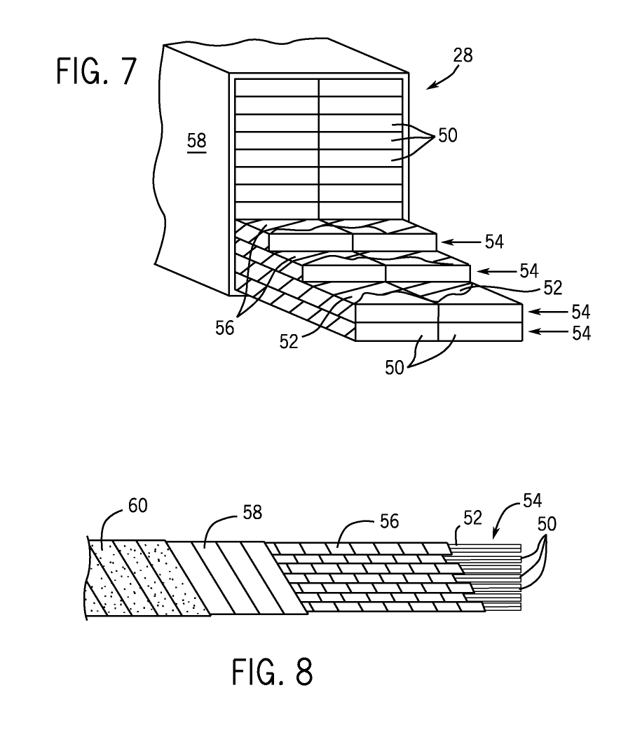

FIGS. 7, 8 and 9 illustrate the various layers of insulation in somewhat greater detail. As best shown in FIG. 7, each coil may comprise a number of individual conductors 50. These conductors are typically rectangular in cross-section and may be stacked vertically, horizontally or both. The conductors are generally made of copper, although various alloys and other materials may be employed. Where desired, the individual conductors may comprise a first level of insulation that is referred to herein as strand insulation 52. In present embodiments this strand insulation may comprise one or more layers of material that is wrapped around the individual conductor in an overlapped arrangement. At least some of the strand insulation 52 may typically be in a tape form, as are other portions of the insulation system described herein. One or more strands may then form a turn 54. In the illustrated embodiment, side-by-side strands form each turn 54. Each turn may then be insulated from other turns by turn insulation (e.g., mica-containing turn tape). With the insulated turns stacked in the formed coil, the insulation system then includes a ground wall insulation 58 that surrounds all turns of the coil. The ground wall insulation, the turn insulation and the strand insulation (where used) will generally extend over the entire length of the coil, including the slot cell sections 32, end arms 36, end winding 38, and knuckle 40. Advantageously, the techniques described herein enable the continuous winding or application of the aforementioned tape layers 44, 46, and 47, thus eliminating overlap or transfer sections when transferring between a first tape reel to a second tape reel.

FIG. 8 illustrates successive layers of insulation as may be provided on an exemplary coil. As noted above, the coil essentially contains conductors 50 over which strand insulation 52 may be applied. The turn insulation 56, then, is provided over each successive turn. The ground wall insulation 58 is provided over all of the turns and thereby over all of the turn insulation. Finally, an armor insulation 60 is provided at certain locations around the coil as described below. In certain embodiments, the layer 52, the layer 56, the layer 58, the layer 60, or a combination thereof, may be each wound in a single continuous winding, thus removing transfer sections that may have been found in the same layer, reducing overall coil area, and improving performance. For example, performance may be improved by adding conductor 50 area by taking advantage of the extra area achieved, for example, during retrofits that apply the techniques described herein.

Referring back to FIG. 6, and keeping in mind the various insulation layers mentioned with reference to FIGS. 7 and 8, the slot cell sections 32 will typically include strand/turn insulation as well as ground wall insulation. The armored layer 60 is provided over the ground wall insulation in the areas where the coil will be placed in the stator slots (i.e., over the slot cell sections). The armored insulation 60 extends beyond portions of the coil that will be placed in the slots, that is, beyond the outer extremities of the stator core. In presently contemplated embodiments, this armored insulation extends beyond the ends of the stator core a minimum of 1 inch, although other extensions may be utilized. In general, this insulation may extend to the first bend of the coil beyond the slot cell sections. The armor insulation is placed over the ground wall insulation, and may comprise a protective layer as described below.

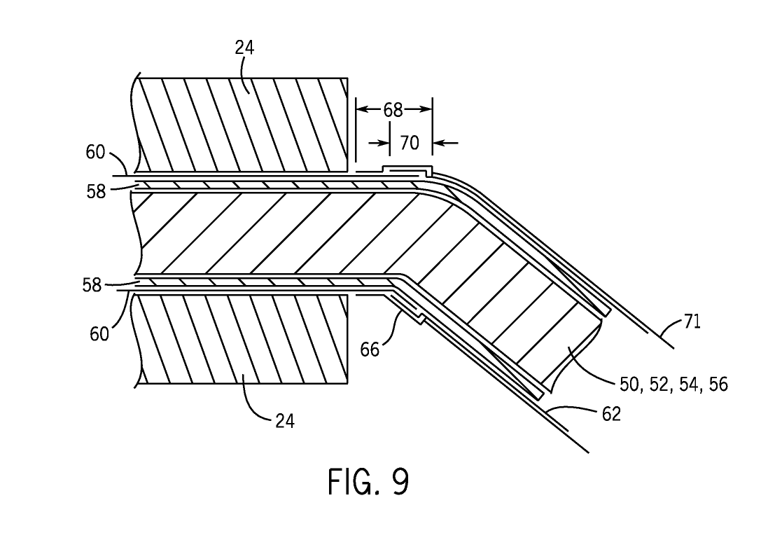

Referring to FIG. 9, the armor insulation 60 is illustrated extending beyond the stator core slot, and may include overlapping in a region 66 with the layer 58. In another embodiment, there may be no overlapping in region 66. In a presently contemplated embodiment, for example, the distance 68 is again approximately 1 inch. The insulations may overlap by a distance 70, such as approximately ¾ inches. Here again, from this point the voltage grading layer may extend approximately 6 inches or so onto the end arm or near the area where the coil is bent.

Referring back to FIGS. 6 and 8, the armor insulation layer 60 comprises a tape that is wound over ends of the coil, and may be wound at least partially (or fully) over the over the ground wall insulation outside of the slot cell cavity sections. The resulting insulation system is highly adaptable to various coil configurations, voltage ratings, dielectric requirements, and a host of other electrical machine specifications. It is also to be noted that other types of tape layers may be used, in lieu of or in addition to the aforementioned layers. For example, if enhanced electrical dissipation is desired, a corona type and/or a gradient tape may be wound into the coil. The gradient and corona tapes may include semiconductor materials useful in partially conducting electricity, thus dissipating electric discharges (e.g., coronas) and/or gradients that may be experienced at higher voltages. Further details on the use of corona and gradient tapes may be found in patent application Ser. No. 13/774,014, filed Feb. 22, 2013, which is incorporated by reference herein in its entirety.

The following summary outlines certain presently contemplated combinations of wire and insulation layer selection along with their performance criteria:

0-25 Volts/Turn Root Mean Square (RMS): Heavy film insulated wire per National Electrical Manufacturers Association (NEMA) standards MW 1000, MW 36-C or double glass insulated per NEMA standards MW 42-C or MW 46-C.

25-40 Volts/Turn RMS: Heavy film insulated per NEMA MW 36-C with single or preferably double (space permitting) Dacron glass serving (e.g., polyethylene terephthalate weave with fiber glass threads) per NEMA MW 46-C. It is to be noted that multiple coated film insulated wire, i.e., Quadfilm (eg., NEMA MW 36-C Quadruple), may be used where space is not available for glass served wire or if additional space is desired, e.g., to increase conductor material.

40-55 Volts/Turn RMS: Heavy film insulated wire per NEMA MW 36-C with all parallel conductors (a turn) wrapped with one layer of two ply mica tape, such as a 2526XS, a 2536XS and/or a 2537XS two-ply mica tape available from Von Roll, USA Inc., of Schenectady N.Y. The mica-containing tape may comprise at least approximately 160 gm/m² of mica. In some embodiments, film tapes such as non-glass served polyethylene terephthalate (PET) or Kapton (e.g., polymide film) are not desired as strand/turn tape insulation.

55-70 Volts/Turn RMS: Heavy film insulated wire per NEMA MW 36-C with all parallel conductors (a turn) wrapped with two layers of the two ply mica tape. The Film tapes such as PET or Kapton are not desired as turn tape.

For VPI coils to be processed in catalyzed epoxy it may be preferable to use 88-205 tape or similar tape as turn tape and strand insulation if desired. The 88-205 tape may comprise an epoxy resin bonded laminate tape construed from a woven glass cloth and phlogopite mica paper. The resin may be accelerated for use with anhydride epoxy VPI systems. The 88-205 tape may be available from Lectromat, Inc., of Mars, Pa.

For VPI coils to be processed in uncatalyzed epoxy it may also be preferable to use 88-205 tape or similar tape as turn tape and strand insulation if desired.

It is also to be noted that multiple coated film insulated wire (e.g., NEMA MW 36-C) with a fused double serving of polyester glass (e.g., NEMA MW 48-C) may be used instead of turn tape where space is not available or additional space is desired.

For the embodiments described above (e.g., 0-70 Volts Turns RMS embodiments), a 100% surge test on all formed coils 28 may be applied per IEEE-522 specification, for example, by applying the schedule set in the table below:

| Line Voltage | Peak | Test Voltage |
|---|---|---|
| 460 | 850 | 2611 VDC |
| 2300 | 450 | 7616 VDC |
| 4000 | 7500 | 12240 VDC |
| 4160 | 8000 | 12675 VDC |
| 6600 | 12250 | 19312 VDC |
| 6900 | 13000 | 20138 VDC |

Which may be based on the formula:

Calculated Surge Test voltage=Line Votage×√2/√3×3.5 pu×0.65 (1)

Accordingly, the formed coils 28 may comply with IEEE-522, among other guidelines.

In one embodiment, for uncatalyzed epoxy resin VPI coil systems operating between 0-6.9 KV, the turn tape insulation may be the 88-205 tape described above; the ground wall tape insulation may be the 2536XS or 2526XS mica tape, and the armor tape may be a 67001 Dacron tape available from Isovolta Inc, of Rutland, Vt.

In another embodiment, for catalyzed epoxy resin VPI coil systems operating between 0-6.9 KV, the turn tape insulation may be the 88-205 tape described above; the ground wall tape insulation may be a 2480XS mica tape available from Von Roll, USA Inc., of Schenectady N.Y., and the armor tape may be an armor shrink Dacron tape, such as a 248150100 armor shrink tape available from Electrolock, Inc., of Greenville, S.C. As noted above, the insulation system may also be suited to medium voltage applications, such as less than 7 KV.

Regarding individual insulation types and layers, the strand insulation, when utilized, will typically provide isolation of the individual strands, and may be used based upon turn-to-turn dielectric requirements. In certain presently contemplated embodiments summarized above, the strand/turn insulation may comprise a film applied over the individual turns and/or strands, such as an underlying coating based on an epoxy resin (e.g., as described above with respect to the 88-205 tape). The film or tape may be constructed from a woven glass cloth and phlogopite mica paper, with the resin accelerated for use with anhydride epoxy VPI systems. The film or tape may be applied in a continuous wrap, thus saving space that may have been used in transitions between the same tape layer.

Moreover, single glass layers may be utilized, where a combination of a single layer of polyester-glass and film are used for the strand/turn insulation. Where used, the glass is an electrical grade filament glass yarn and a polyester utilized is a high grade yarn made from a glycol-acid polymerization. Still further, double layers of polyester glass and film may be used for the strand/turn insulation. In such cases, the glass and polyester are similar to those in the single layer case. In addition, a combination of a mica-contained tape and film may be utilized. In a presently contemplated embodiment, the mica tape comprises a muscovite mica paper impregnated with an electrical grade modified epoxy resin, both sides being covered with a polyethylene terephthalate (PETP) film. Finally, one or more overlapped tapes may be utilized, such as a glass-backed high-porosity mica tape applied over the turned bundle. The mica tape, when utilized, is typically the same material used for the ground wall insulation discussed below, and the strands may be insulated with film, glass or a combination thereof.

As noted above, the various layers of the strand/turn insulation may be selected based upon the desired dielectric strength, as indicated in the summaries above. Moreover, the number and types of successive layers may be selected based upon the anticipated volts per turn potential difference. In general, a film is used, or a combination of glass and film may be used successively. If further potential differences are to be encountered, the mica/film layer, micafold, and tape/film layers may be added.

In presently contemplated embodiments, the ground wall insulation is then applied over the strand/turn insulation. The ground wall insulation is typically applied in a single continuous wrap. That is, the insulation layer may be applied without overlap between a first and a second tape wrap in the same layer, thus saving space. To optimize the insulation system the tape tension is controlled at approximately 16-18 ft-lbs by an automatic taping machine. The final size is then checked with a slot fit gage to ensure that the insulated coil will fit within the stator slots. As also summarized in the tabulated summary above, the mica content of the ground wall insulation is preferably high, on the order of 160 gm/m², but other contents may be used. The number of wrapped layers may be selected based upon the operating voltage and rating of the machine, as noted above.

The armored insulation is also applied as a tape in one continuous wrap. In presently contemplated embodiments, the armored insulation may be applied over the ground wall tape. In presently contemplated embodiments, the armored tape is applied in one ½ overlap layer. In one embodiment, the armored tape may have a thickness of between 4 to 5.5 mm and have an elongation property of 20% minimum, such as the 67001 armor tape. In another embodiment, the armor tape may include armor shrink tape (e.g., 24815010 armor shrink tape) with a shrinkage property of 8-12%, thus more comformably fitting to the core. The length of this insulation may extend between 4 and 6 inches along the coil at each end. The armored layer serves to further protect the coil.

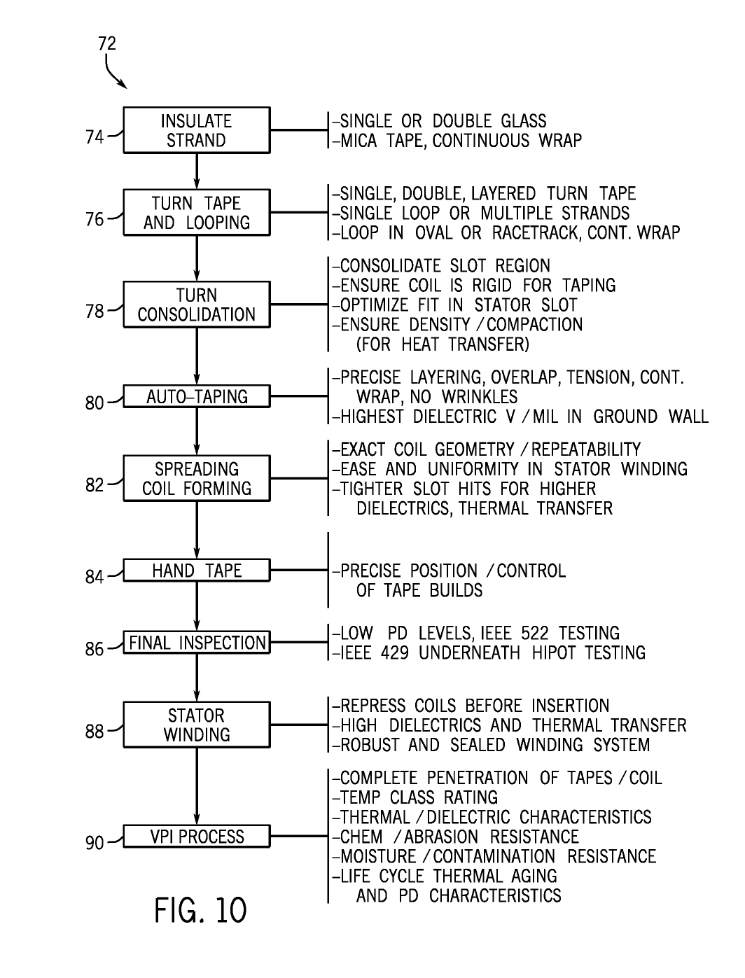

As noted above, the insulation system may be applied at various stages, both by hand and utilizing automatic taping machines. FIG. 10 illustrates exemplary steps in forming and insulating the coils, along with certain details regarding the process, and advantages of each step. The process, designated generally by reference numeral 72, may begin by removing any previous insulation for coils that are to be refurbished. For newly manufactured coils, the process 72 begins with applying any desired strand insulation as indicated at step 74. As noted above, such strand insulation may comprise resins, tapes, and so forth, with the tape being overlapped when required, but typically wound in one continuous wounding. The strand insulation, again, depends upon the dielectric rating desired for the strands. Subsequently, turn tapes may be applied as indicated at step 76. As noted above, these may comprise single, double and layered turn tapes, which may be applied in single conductor or multiple strand loops, again, as a single continuous wounding. In general, the turn tapes will surround each turn of the coil as it is formed.

At step 78, a forming process is performed that comprises turn consolidation. In general, this a sizing process that consolidates the turns in the slot cell regions to ensure the coil is rigid for taping and optimally sized to fit within the stator slot. The turn consolidation also ensures the desired density and compaction, such as for thermal transfer.

Once consolidated, automatic taping may be performed as indicated at step 80. This automatic taping allows for precise layering, overlapping and tension of the ground wall insulation with no wrinkles or pockets between the turn insulation and within the ground wall insulation. The automatic taping process (e.g., automatic continuous wounding) allows for highest dielectric rating in the ground wall layer.

Subsequently, the coil may be formed at step 82 to ensure proper geometry with the stator core and repeatability of coil nesting. In presently contemplated embodiments, the coil forming is performed via automated control of forming machines, although the process may be more or less automated.

Finally, at step 84 hand taping may be performed, such as for the additional insulation layers as described above (e.g., the end turn and knuckle ground wall layers, the armor tape). Moreover, in this step lead sealing may be performed.

With the coil insulated and formed, a final inspection and testing takes place at step 86, which may include surge, high voltage, and polarization index testing. The coils are then complete and the stator may be wound as indicated at step 88. As will be appreciated by those skilled in the art, this winding process typically comprises positioning and pressing the insulated coils into the stator core slots in accordance with the machine design.

Finally, at step 90 a vacuum pressure impregnation process is performed. The process allows for complete penetration of the tapes in various layers around the coil, provides for the appropriate temperature class rating, as well as for the thermal/dielectric characteristics desired. The completed stator may be subjected to final tests such as water emersion and AC hipot testing. Moreover, this VPI process provides chemical and abrasion resistance, moisture and contamination resistance, and enhances the life of the coil, particularly during cyclic thermal aging and from partial discharge.

Other features and advantages of the insulation system described above are offered. For example, thinner denser groundwalls transfer heat more efficiently reducing electrical losses (e.g., more compact, permitting uprating of the machine).

The summary table presented below provides some example wrapping values useful for low to medium voltage insulation for systems processed in uncatalyzed epoxy resin as follows:

| Operating | Ground | | |
|---|---|---|---|
| Volt. | Wall (min.) | End turns | Lead Insulation |
| 0 to 1 KV | 2½ laps | 2½ laps | 2½ laps (sealed with felt) |
| 1 to 3 KV | 3½ laps | 3½ laps | 3½ laps (sealed with felt) |
| 3 to 5 KV | 4½ laps | 4½ laps | 4½ laps (sealed with felt) |
| 5 to 6.9 KV | 6½ laps | 5 or 6½ laps | 6½ laps (sealed with felt) |

The materials for the ground wall lapping, end turn lapping, and lead insulation lapping typically may include ground wall insulation 58, turn insulation 56, and armor insulation 60.

In some systems, it may be desired to include sleeved leads. Accordingly, the table below provides some example wrapping values useful for low to medium voltage insulation for systems processed in uncatalyzed epoxy resin with sleeved leads as follows:

| Operating | Ground | | |
|---|---|---|---|
| Volt. | Wall (min.) | End turns | Sleeved Lead Insulation |
| 0 to 1 KV | 2½ laps | 2½ laps | Fiberglass reinforced |
| 1 to 3 KV | 3½ laps | 3½ laps | Fiberglass reinforced |
| 3 to 5 KV | 4½ laps | 4½ laps | Fiberglass reinforced |
| 5 to 6.9 KV | 5½ laps | 5½ laps | Triple Fiberglass |
| | | | reinforced |

The materials for the ground wall lapping, end turn lapping, and lead insulation lapping typically may include ground wall insulation 58, turn insulation 56, and armor insulation 60. It is to be noted that the fiberglass reinforcement may include Grade A fiberglass reinforcement, and that the triple fiberglass reinforcement may include triple wall reinforcement. It is also to be noted that the triple fiberglass reinforcement may be replaced with 5½ laps of material, e.g., armor insulation 60.

The summary table presented below provides some example wrapping values useful for low to medium voltage insulation for systems processed in catalyzed epoxy resin with sleeved leads as follows:

| Operating | Ground | | |
|---|---|---|---|
| Volt. | Wall (min.) | End turns | Lead Insulation |
| 0 to 1 KV | mica ½ lap | mica ½ lap | Fiberglass reinforced |
| 1 to 3 KV | 3½ laps | 3½ laps | Fiberglass reinforced |
| 3 to 5 KV | 4½ laps | 4½ laps | Fiberglass reinforced |
| 5 to 6.9 KV | 5½ laps | 5½ laps | Triple Fiberglass |
| | | | reinforced |

The materials for the ground wall lapping, end turn lapping, and lead insulation lapping typically may include ground wall insulation 58, turn insulation 56, and armor insulation 60. It is to be noted that the fiberglass reinforcement may include Grade A fiberglass reinforcement, and that the triple fiberglass reinforcement may include triple wall reinforcement. It is also to be noted that the triple fiberglass reinforcement may be replaced with 5½ laps of material, e.g., armor insulation 60. The lapping tables presented above may result in insulation having

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electrical machine formed coil insulation system, comprising:
turn insulation disposed over each successive turn of the formed coil;
multi-layer of mica ground wall insulation disposed over multiple turns of the coil; and
armor insulation disposed over ends of the coil and at least a portion of coil leads, wherein the turn insulation is disposed in one continuous wrap, and wherein the formed coil insulation system is rated for an electrical machine operating at between 0 and 7,000 volts.

2. The system of claim 1, wherein the formed coil comprises a refurbished coil having at least 10 hours of operation.

3. The system of claim 1, wherein individual conductors of each turn comprises a strand insulation disposed between the respective conductor and the turn insulation.

4. The system of claim 1, wherein the turn insulation comprises at least one layer of a mica-containing tape.

5. The system of claim 1, wherein the ground wall insulation comprises at least one layer of a mica-containing tape.

6. The system of claim 5, wherein the mica-containing tape is wound in ½ lap overlap with a ¼ lap index.

7. The system of claim 5, wherein the mica-containing tape comprises at least approximately 160 gm/m² of mica.

8. The system of claim 4, wherein the turn insulation comprises a first ply comprising a phlogopite mica paper and a second ply comprising a woven glass cloth.

9. The system of claim 1, wherein the armor insulation is disposed at least partially over the multi-layer of mica ground wall insulation.

10. The system of claim 1, wherein an application tension of the armor insulation does not exceed an application tension of the ground wall insulation.

11. The system of claim 1, wherein the armor insulation comprises a tape applied with an approximate ¾ to 1 inch overlap.

12. The system of claim 1, wherein the armor insulation comprises a shrinking armor insulation.

13. The system of claim 1, wherein the electrical machine comprises a motor, a generator, or a combination thereof, and the formed coil comprises a stator coil.

14. An electrical machine refurbished formed coil insulation system, comprising:
turn insulation comprising at least one layer of a mica-containing tape disposed over each successive turn of substantially the entire formed coil;
multi-layer of mica ground wall insulation comprising at least one layer of a mica-containing tape disposed over multiple turns of substantially the entire the coil; and
armor insulation disposed over at least a portion of the ground wall insulation of at least slot cell cavity sections of the coil and extending beyond ends of a core of the machine, wherein the turn insulation is disposed in one continuous wrap.

15. A method for refurbishing insulation of an electrical machine formed coil, comprising:
removing previous insulation from the formed coil;
wrapping a turn insulation over each successive turn of the formed coil;
wrapping a multi-layer of mica ground wall insulation over multiple turns of the coil;
wrapping an armor insulation over the ground wall insulation of slot cell sections of the coil and extending beyond ends of a core of the machine; and
vacuum pressure impregnating the coil and insulations, wherein the turn insulation is wrapped in one continuous wrap.

16. The method of claim 15, comprising winding the coil after or during wrapping the turn insulation.

17. The method of claim 15, comprising consolidating the turns of the coil in the slot cell cavity sections after wrapping the turn insulation.

18. The method of claim 15, comprising wrapping the multi-layer of mica ground wall insulation in one continuous ground wall wrap, wrapping the armor insulation in one continuous armor wrap, or a combination thereof.

19. The method of claim 15, comprising installing multiple generally similar coils in the core of the machine, and lacing and connecting leads of the coils into groups prior to vacuum pressure impregnating the coils and insulations.

20. The method of claim 15, comprising wrapping conductors of the coil with strand insulation prior to wrapping the turn insulation.
